(19) United States
(12) Patent Application Publication
(10) Pub. No.: US 2008/0183603 A1
(43) Pub. Date: Jul. 31, 2008

(54) POLICY ENFORCEMENT OVER HETEROGENEOUS ASSETS

(75) Inventors: Pravin Kothari, San Jose, CA (US); Yuh-Wen Soung, Saratoga, CA (US)

Correspondence Address: LEVINE BAGADE HAN LLP, 2483 EAST BAYSHORE ROAD, SUITE 100, PALO ALTO, CA, 94303, US

(73) Assignee: Agiliarice, Inc., Mountain View, CA (US)

(21) Appl. No.: 11/669,130

(22) Filed: Jan. 30, 2007

(51) Int. Cl. G06Q 10/00

(52) U.S. Cl. 705/30

(57) ABSTRACT

One policy can be enforced over heterogeneous assets by having connectors monitoring assets execute asset type related checks to enforce the policy. In one embodiment, the present invention includes receiving, at one such connector managing a plurality of assets, an assignment of a policy to an asset of the plurality of assets from a server. In response to the assignment, the connector attempts to retrieve one or more automated checks to enforce the policy against the asset using information about an asset type of the asset, and then executes the retrieved automated checks against the first asset if at least one automated check was retrieved.

### BACKGROUND

1. Field

Embodiments of the present invention apply to the field of network security and policy enforcement, more specifically policy and control compliance.

2. Description of the Related Art

Modern business enterprises operate in a complex regulatory environment. Many enterprises must comply with various government regulations both on the federal level and on the state and local levels. For example, most public corporations (at the present time any publicly traded corporation with fifty million or more market capitalization) must comply with the Sarbanes-Oxley Act of 2002. Financial enterprises, heath related enterprises, and other more stringently regulated industries have their own regulatory frameworks.

Furthermore, many business enterprises have internal policies and controls independent of government regulation. These controls and policies may be concerned with security, confidentiality maintenance, trade secret protection, access control, best practices, accounting standards, business process policies, and other such internal rules and controls. The cost of complying with all regulations, rules, policies, and other requirements can be substantial for a large scale business enterprise.

What is needed is a system to enforce controls and policies over the business assets of an enterprise. On difficulty faced by such a system is the distribution and automated enforcement of policies over heterogeneous assets.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a compliance management system according to one embodiment of the present invention;

FIG. 2 is a block diagram illustrating a user interface module for a compliance management system according to one embodiment of the present invention;

FIG. 3 is a block diagram illustrating a policy module and it's relation to connectors and assets according to one embodiment of the present invention;

FIG. 4 is a flow diagram illustrating policy enforcement according to one embodiment of the present invention;

FIG. 5 is a flow diagram further illustrating policy enforcement result interpretation according to one embodiment of the present invention; and

FIG. 6 is a block diagram illustrating an example computer system according to one embodiment of the present invention.

### DETAILED DESCRIPTION

Compliance and Risk Management System

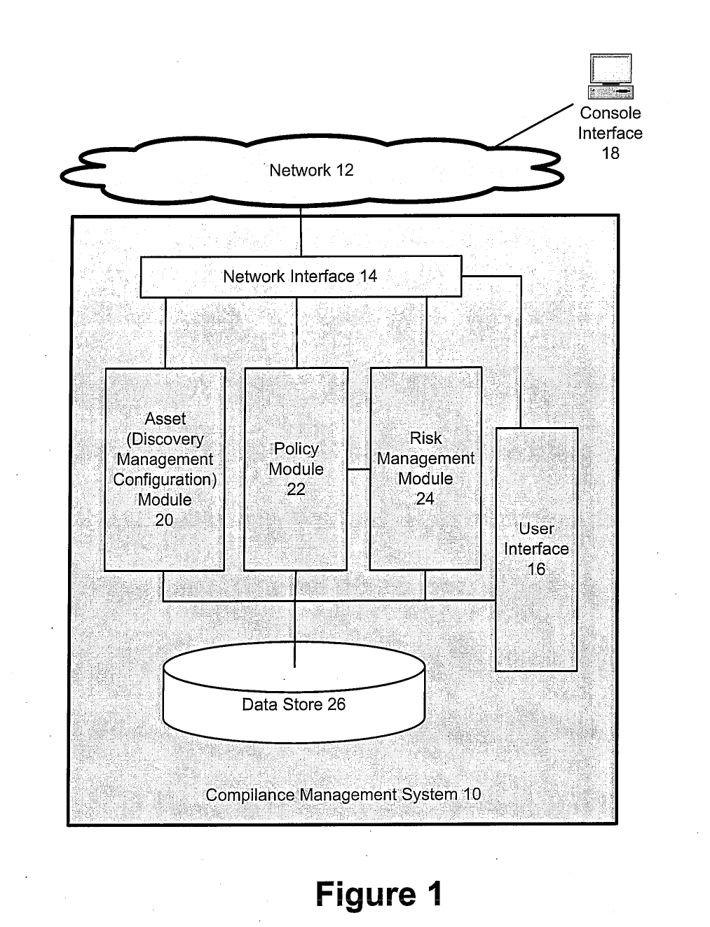

One embodiment of the invention is now described with reference to FIG. 1. FIG. 1 shows a compliance management system 10. In FIG. 1, the compliance management system 10 is shown as a stand-alone appliance that connects to a network 12, but the compliance management system 10 can be provided in other ways, such as software running on a server, distributed software, or various software and hardware packages operating together.

The compliance management system 10 connects to a network 12—such as a local area network (LAN), Intranet network segment, or the Internet, using a network interface 14. Via this network interface 14, the compliance management system 10 can interface with various hardware and software connected to the network 12. The compliance management system 10 may interface with assets managed by the compliance management system 10 and with agents, connectors, and concentrators used to manage such assets.

A connector used by the compliance management system 10 can be custom designed connector used to collect data from and to manage various network devices and network management and security products already installed by the enterprise, such as, routers, firewalls, directories (such as Microsoft's Active Directory), vulnerability scanners, security information management (SIM) products, enterprise risk management (ERM) products and other such products and applications. In contrast, an agent (also known as a software agent) is distributed software residing on a managed asset.

In one embodiment, the compliance management system 10 implements asset discovery, configuration, and management functionalities using the asset module 20 shown in FIG. 1. The asset module can interface with the various agents, connectors, and concentrators (sometimes referred to collectively as “software interfaces” or “distributed software interfaces”) via the network interface 14. The asset module 20 performs asset discovery by collecting information about all assets connected to and/or visible to the network 12 that are to be managed by the compliance management system 10.

Such managed assets can include, but are not limited to, laptops, desktops, workstations, operating systems and other applications, servers, users, routers, intrusions detection devices (IDS), firewalls, printers, and storage systems. Assets can be imported from various connected applications, such as vulnerability scanners, directory applications, ERM, SIM, and other security-related products, and so on. Assets can also be non-information technology assets, such as people, users, buildings, and so on. Some assets, such as buildings, departments, and networks include other assets. Assets can also be grouped into asset groups using some filtering or grouping criteria.

In one embodiment, the asset module 20 can also be used to configure asset attributes. This can be done by an operator of the compliance management system 10 via the user interface 16 exposed to the user by a console 18. There may be more or less consoles, which will be collectively referred to as console interface 18. In FIG. 1, the console interface 18 is a browser-based interface accessed via the network 12.

As an example of asset attribute configuration, a connector (e.g., the active directory connector) can report a newly discovered laptop computer. The connector can automatically report back on available attributes, such as central processing unity (CPU) type, the operating system running on the laptop, the types of memory installed, and so on. A user (typically a system administrator) can then add extra attributes to the laptop, such as business owner, business classification, group, and other similar attributes.

The discovered and configured assets can be stored, in one embodiment, in data store 26. Data store 26 can be implemented as a disk, a data server, or some other physical storage means. It can reside inside or outside of the compliance management system 10. The data store 26 can include various databases. One such database can be an asset database, having records corresponding with managed assets. The assets discovered and stored in the asset database can be managed, in one embodiment, from the console interface 18 by editing various attributes of the assets.

In one embodiment, policy compliance functionality is provided by the compliance management system 10 by a policy module 22. The policy module 22 can enable a user—via the user interface 16—to author and edit policies and policy templates and apply policies to various assets. The policy module 22 also maintains a policy database in the data store 22. In one embodiment, policies can also be labeled, grouped and organized according to certain predefined roles for personnel. For example, “engineer level 1” can be a role that has a list of specific policies associated with it.

In one embodiment, the compliance management system 10 also provides risk management functionality by implementing a risk management module 24. Such system could be called a compliance/risk management system, or risk management system, but to avoid confusion, the system will be referred to as a compliance management system 10. The risk assessment module 24 analyzes multiple sources of information, including the compliance management system 10, to determine the risk the enterprise is exposed to. In one embodiment, the risk management module collects information—in addition to the compliance management system—from the enterprise's vulnerability assessment systems, SIM systems, asset configurations, and network traffic reports. Other sources of information may be used as well. In one embodiment, the risk management module determines a simple metric to express the enterprise's risk profile using all the collected information.

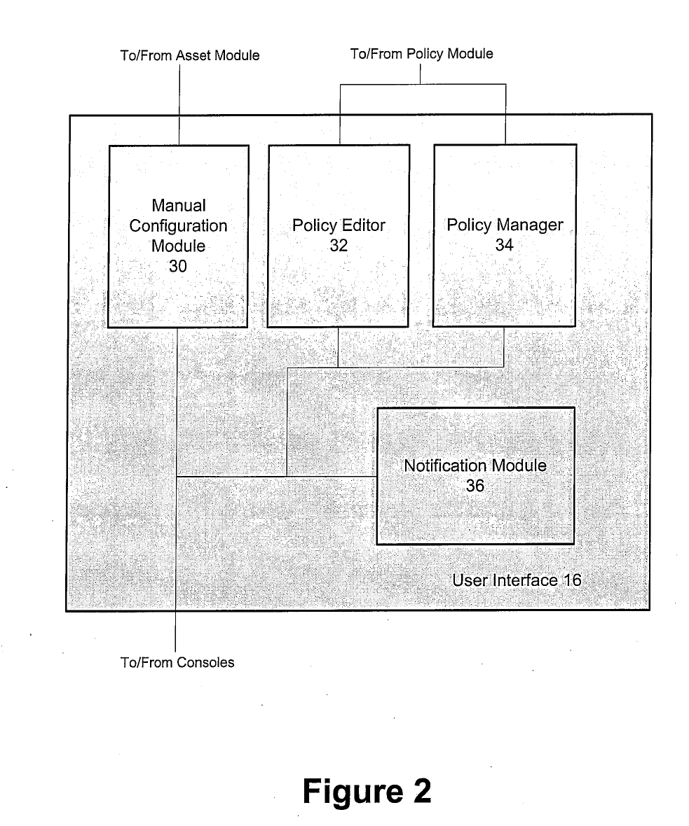

As mentioned above, the compliance management system 2 also includes a user interface 16 which is exposed to users of the system 10 by consoles 18. In one embodiment, the user interface enables an administrator to select from a list of regulations—such as Sarbanes-Oxley (SOX), Gramm-Leach-Bliley Act (GLBA), Health Insurance Portability and Accountability Act (HIPPA), Card Holder Information Regulation Program (CISP)—and display functionality relevant to the selected regulation. Similarly, the user interface can enable an administrator to select from a list of standard frameworks—such as ISO-17799, Control Objectives for Information and related Technologies (COBIT)—and display functionality relevant to the selected regulation or framework. FIG. 2 provides a more detailed view of the user interface 16 according to one embodiment of the present invention.

The user interface 16 can implement a manual configuration module 30 that allows the user to manually configure asset attributes, as described in the example of the laptop being assigned to a business owner (and other user-defined attributes) above. The user interface can also implement a policy editor 32. The policy editor 32 can assist users in naming and authoring policies.

The policy editor 32 can also provide access to a policy template database stored on the data store 26 having template policies. A user can then create a specific policy instance using a preconfigured template by saving the policy instance as a policy. The policy editor 32, in one embodiment, also includes access to a script-based policy language that allows for highly flexible authoring of almost any type of desired policy. In addition, the policy editor 32 can be used to edit saved policies and policies from various preconfigured policy databases as well as author and edit policy templates.

In one embodiment, the policies that can be authored by the policy editor 32 are highly flexible. Such policies include technology-based policies, such as password length and firewall configurations. Furthermore, some policies can be process related, ensuring that certain process owners take certain actions. Yet other types of polices can include some that cannot be automatically enforced in an information technology sense. For example, risk assessment surveys must be manually filled out by someone responsible for the domain being surveyed, and a policy can include the requiring of such a survey being filled out periodically. Since such policies require at least some human interaction, they are sometimes referred to herein as “manual” policies.

The user interface 16 can also implement a policy manager 34. The policy manager 34 allows the user to organize and apply policies. Policies can be associated with controls that are designed to mitigate against specific threats, as defined in various standards, such as ISO-17799. In one embodiment, the policy manager can be used to identify threats, define (or import) controls, and associate policies to controls to implement the controls. One control may be implemented using several policies, and a policy may be occasionally used in multiple controls. In one embodiment, policies are applied directly to assets or groups of assets. The user interface 16 can also include a notification module 36 to send alerts and reports regarding compliance management and risk analysis.

Policy Distribution and Enforcement

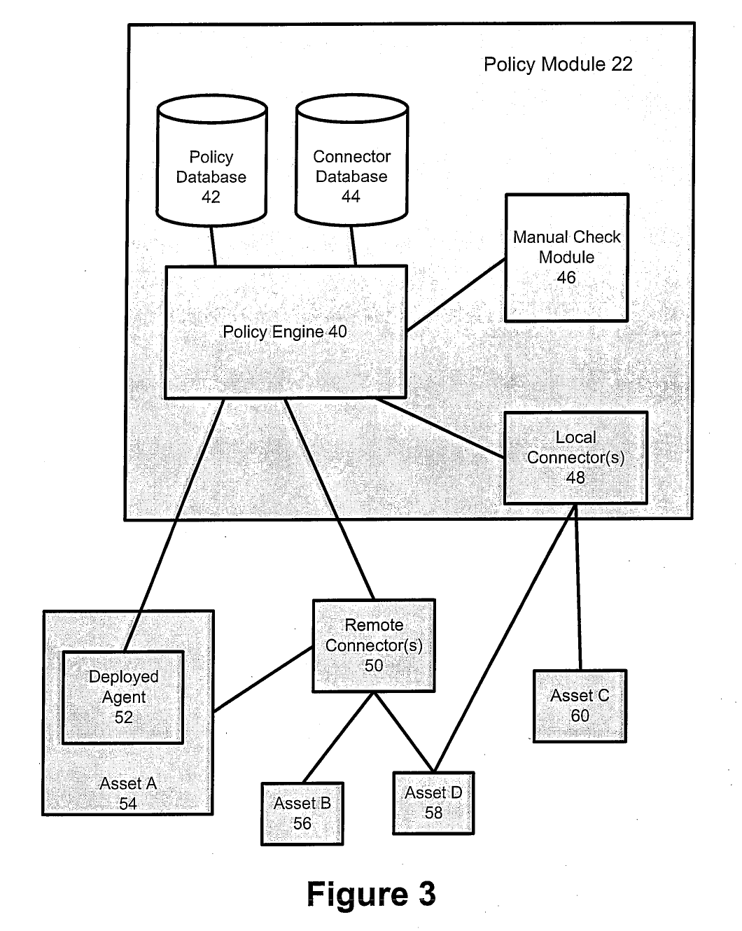

As described above, the compliance management system 10 can enforce various policies over various assets. As described above, the assets come from a large and diverse group of heterogeneous assets. Some assets may be machines of different types, such as routers or servers, others may be applications and processes. Policy distribution and enforcement according to one embodiment of the present invention is now described with reference to FIG. 3.

FIG. 3 shows the policy module 22 discussed with reference to FIG. 1 in more detail. The policy module 22 includes a policy engine 40. The policy engine 40 controls the assignment, distribution, and enforcement of policies, as well as the reporting on the compliance with the policies. The policies and stored in a policy database 42 accessible by the policy engine 40. The policies in the policy database 42 may have been created by a user or they may be or include standard policies pre-programmed with the system 2.

The policy database also provides the association between policies, and the assets to which the policies are applied. When a user applies a policy or set of polices to an asset or group of assets, the necessary information about the assets is retrieved from the asset module 20, and the association is made in the policy database 42.

When the policy module 40 decides to enforce a policy, it can retrieve the assets against which the policy needs to be enforced from the policy database 42. Next, the policy engine needs to determine to which connector or connectors the policy should be pushed. To accomplish this task, the policy engine 40 can access the connector database 44. The connector database 44 maintains the association between assets and connectors monitoring the assets.

In one embodiment, there are several different types of connectors used by the system 2. One type of connector is a local connector 48. A local connector 48 resides on the server and communicates with assets or other asset monitoring tools directly. Once example of a local connector 48 is an Active Directory connector (“AD connector.”) The AD connector collects information from an Active Directory installation. The AD connector can query the AD installation and send information about various assets—e.g., computers, and user accounts—and organizational unit and group information to server. Other examples of local connectors are the Foundstone connector, the Oracle connector, and the WebInspect connector, each of which is an interface with the application bearing the name of the connector. Some objectives of these local connectors are to retrieve security vulnerabilities and configuration information and to run policy checks.

Another type of connector is a remote connector 50. Remote connectors 50 are located on the subnets—network segment—being monitored by the system 2, but not installed on individual assets. The remote connector 50 is used to query a specific subnet to discover new assets, such as desktop computers, servers and other network devices and managed by the system 2. The remote connector connects with remote hosts over the network and detects the operating system, such as Windows, Linux, or Solaris. Once the remote connector 50 is in communication with remote hosts, the connector can then collect and monitor security related asset information and run policy checks.

Yet another type of connector is a connector residing on an asset, generally referred to as an “agent” 52. An agent 52 is directly associated with and residing on an asset. One advantage of an installed agent is that the agent 52 can control the asset it is installed on, rather than just passively collect data. The advantages of the agent is that it requires less configuration changes in firewall systems and has easy access to local resources on the host asset and hence can perform checks which may not be possible using the remote connector. A disadvantage of the agent is that they must be individually installed on monitored assets and introduce some complexity and overhead into the system.

An asset may be monitored and associated with more than one connector. For example, in the highly simplified example shown in FIG. 3, Asset A 54 is monitored by deployed agent 52 and remote connector 50. Similarly, Asset D 58 is monitored by both remote connector 50 and local connector 48. Other assets, such as Asset C 60, are only monitored by one connector.

When the policy engine 40 needs to enforce a policy against assets, it can retrieve which connectors the policy should be pushed to from the connector database 44. For example Asset D 58 will be associated with remote connector 50 and local connector 48 in the connector database 44. The policy engine 40 then pushes to policy to be enforced to the appropriate connectors. The policy engine need not be aware about the types of assets the policy will be enforced against or even of whether the policy can be enforced against all the assets attempted.

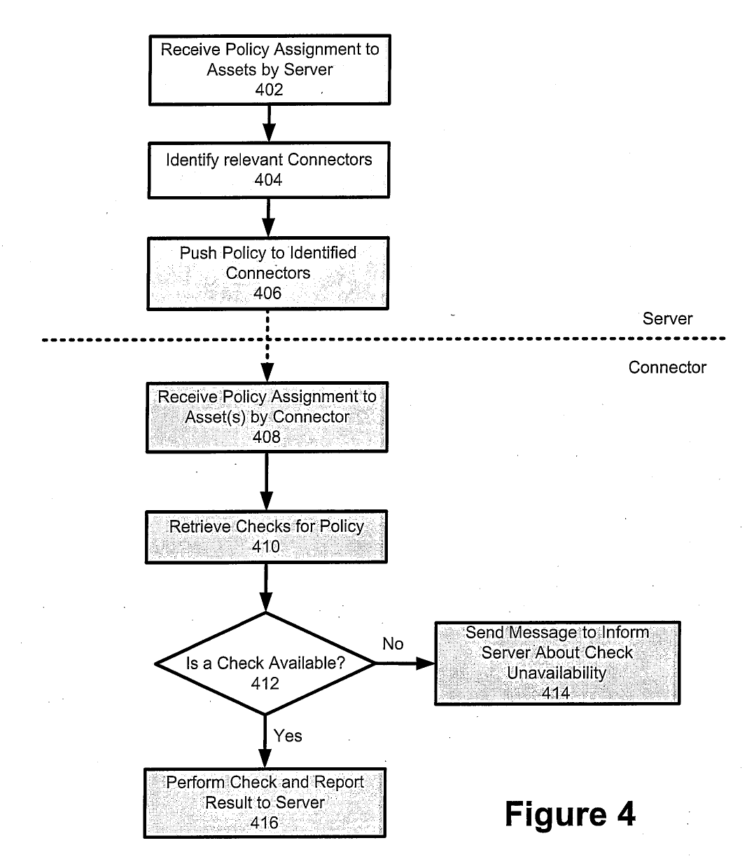

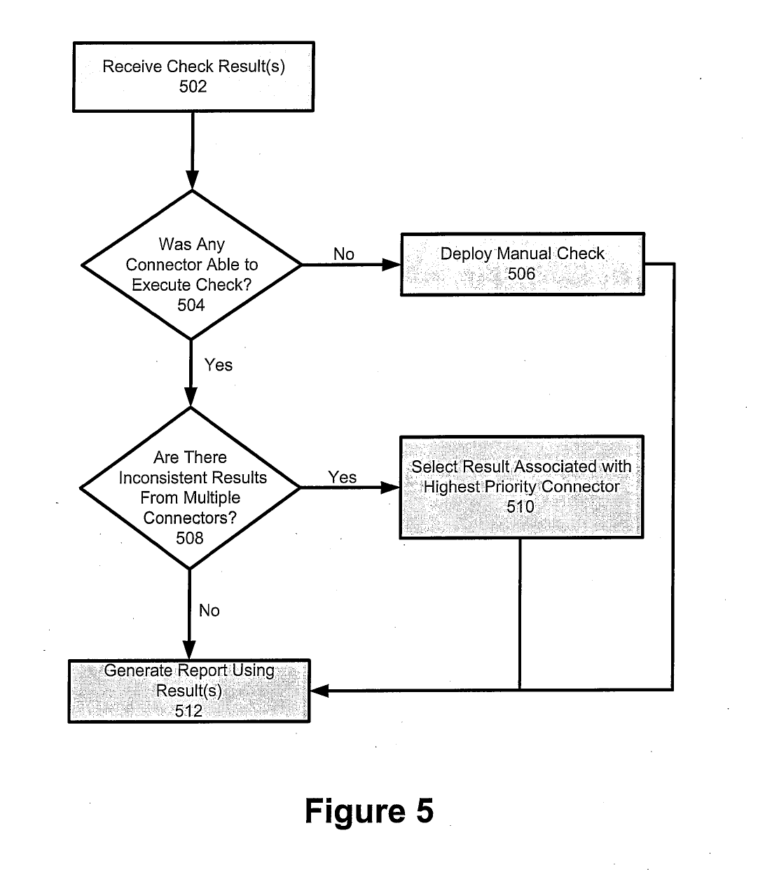

The connectors then enforce the policy against assets monitored by the connectors, and report back to the policy engine 40 residing on the server. One embodiment of such distributed policy enforcement is not described with reference to FIG. 4 and FIG. 5. To simplify the description, the case of a single policy being enforced against a single asset is described. However, the method described can be adapted to be used for multiple policies and multiple assets. In block 402, the server—and the policy engine 40 in particular—receives the assignment of a policy to an asset. In another embodiment, several policies could be assigned to multiple assets or groups of assets.

In block 404, the policy engine 40 identifies the relevant connectors for the asset. In other words, the connectors monitoring the asset against which the policy is to enforced is identified. In one embodiment, this is done by looking up the asset in the connector database 44 and noting the connector associated with the asset. Once the connectors are identified, in block 406, the policy to be enforced over the selected asset is pushed to the identified connectors.

For simplicity and easy of understanding, the description of blocks 408-416 will be limited to the processing preformed by one of the connectors to which the policy was pushed. The other connectors perform a similar method in performing policy checks. In block 408, one of the identified connectors receives the policy assignment and the asset list that the received policy is to be enforced against.

In block 410, the connector identifies the checks needed to be run against the specified asset. Since the connector manages the asset it has the information required about the type and kind of asset needed to select the appropriate checks. For example, the same policy could need different checks when enforced against different asset types. In one embodiment, the connector can access all the checks associated with the policy, and select the ones that are associated with the specific asset. For example, the connector may have several password length checks, one for each asset type. Other assets, such as printers for example, may not have such checks.

In block 412, a determination is made as to whether there is a check—also referred to as an automated check—that can be performed on the indicated asset. As explained above, if a password length policy is assigned to a printer or other asset with no passwords, the connector will not locate any checks it can execute to enforce the policy. If the check or checks associated with the policy are not applicable to the selected asset, the determination is that no checks can be performed.

If a check is determined to be not available in block 412, then, in block 414, the connector informs the server—the policy engine 40 in particular—about the unavailability of any automated checks to execute the specified policy against the specified asset. However, if one or more checks are available to execute the specified policy against the specified asset, then, in block 416, the check (or checks) is executed by the connector. Some examples of such automated checks are a registry test, an allowed/disallowed applications check, an allowed services checks, a Firewall check, an anti-virus system check, a file content test, and a minimum password length check.

Processing of the results of the connector action that is performed by the server is now described with reference to FIG. 5. In block 502, the policy engine 40 receives the results from the connector or connectors that were associated with the asset in the connector database 44. This could be one connector or multiple connectors, such as for Asset D 58 being managed by both local connector 48 and by remote connector 50 in FIG. 3.

In block 504, a determination is made as to whether any of the connectors was able to execute the automated checks required to enforce the policy. If no connector was able to enforce the checks required—that is all relevant connectors reached block 414 of FIG. 4 having found no available checks—then, in block 506, the policy engine 40 instructs the manual check module 46 to deploy a manual check to enforce the policy. In one embodiment, a manual check is a survey sent to on or more asset owners that may be associated with the identified asset in the asset database managed by the asset module 20.

However, if in block 504 it is determined that one or more connectors were able to execute an automated check against the designated asset, then in block 508, the policy engine 40 determines whether there have been multiple inconsistent results reported back to the server. If there is only one connector associated with the asset, or if only one connector was able to execute a check, this is not a concern and processing continues at block 512. However, if two or more connectors were able to execute a check against the asset, conflicting results may have been provided to the server.

If in block 508 it is determined that such conflicting results have been received, then, in block 510, the results are prioritized. In one embodiment, prioritization is carried out by selecting the top priority result and discarding lower priority results. In one embodiment, the connector database 44, in addition to storing the asset to connector relationships, also indicates for each asset the priority of the connectors that manage the asset. In such a case, in block 510, the policy engine 40 selects the results reported by the top priority connector.

Finally, in block 512, a report of the enforcement of the policy over the asset is generated. The report can be stored for later use, or reported directly to an administrator via the user interface 16. As can be observed from the description above, the policy engine does not need to be aware of the various asset types against which it is enforcing policies. The automated checking is handled at the connector level, thereby making policy enforcement to assets transparent to the policy module, thereby greatly reducing complexity and difficulty when configuring the policy module and assigning and creating policies.

Example Computer System

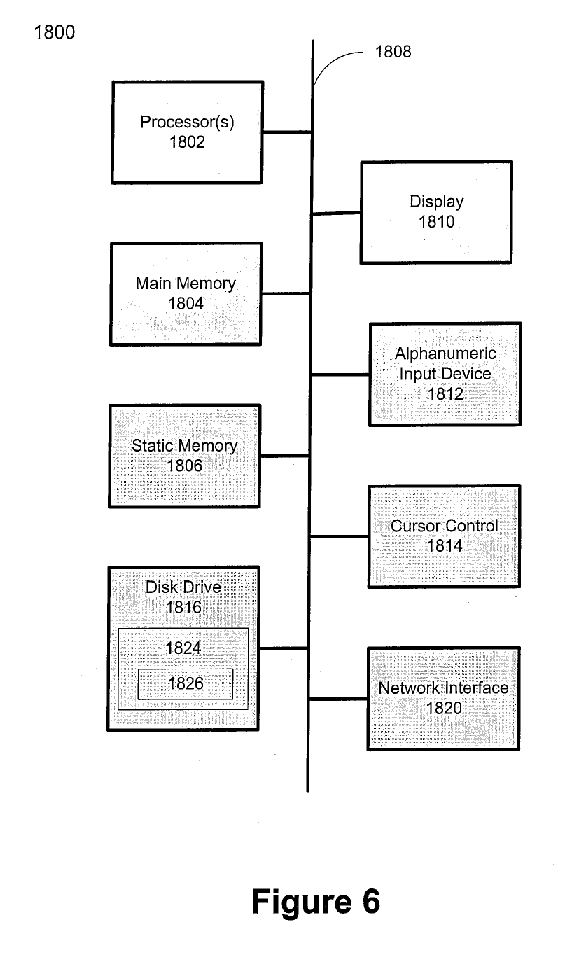

Various embodiments of the present invention have been described in the context of a server that performs compliance, security, and risk management functionalities, and a browser/console interface operable to access and view those functionalities. An example computer system on which such server and/or console interface can be implemented in now described with reference to FIG. 6. Numerous features described with reference to FIG. 6 can be omitted, e.g., a server will generally not include video display unit 1810. Computer system 1800 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1800 includes a processor 1802, a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alpha-numeric input device 1812 (e.g., a keyboard), a cursor control device 1814 (e.g., a mouse), a disk drive unit 1816, and a network interface device 1820.

The disk drive unit 1816 includes a machine-readable medium 1824 on which is stored a set of instructions (i.e., software) 1826 embodying any one, or all, of the methodologies described above. The software 1826 is also shown to reside, completely or at least partially, within the main memory 1804 and/or within the processor 1802. The software 1826 may further be transmitted or received via the network interface device 1822. For the purposes of this specification, the term “machine-readable medium” shall be taken to include any medium that is capable of storing or encoding a sequence of instructions for execution by the computer and that cause the computer to perform any one of the methodologies of the present invention. The term “machine-readable medium” shall accordingly be taken to include, but not be limited to, solid-state memories, optical and magnetic disks, and carrier wave signals.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Embodiments of the present invention may be provided as a computer program product that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving, at a connector managing a plurality of assets, an assignment of a policy to a first asset of the plurality of assets from a server;
attempting to retrieve one or more automated checks to enforce the policy against the first asset using information about an asset type of the first asset; and
executing the retrieved automated checks against the first asset if at least one automated check was retrieved.

2. The method of claim 1, further comprising sending a message to the server to inform the server that no automated checks are available if the attempting to retrieve one of more automated checks is unsuccessful.

3. The method of claim 2, further comprising receiving the message at the server and deploying a manual check to enforce the policy against the first asset in response to the received message.

4. The method of claim 3, wherein deploying the manual check comprises sending a survey to be filled out by an owner of the first asset.

5. The method of claim 1, further comprising:
receiving, at a second connector managing a plurality of assets, an assignment of a policy to the first asset of the plurality of assets from the server;
attempting, by the second connector, to retrieve one or more second automated checks to execute the policy against the first asset using information about an asset type of the first asset; and
executing, by the second connector, the retrieved second automated checks against the first asset if at least one second automated check was retrieved.

6. The method of claim 5, further comprising receiving a first result of the automated checks from the first connector at the server, and receiving a second result of the second automated checks from the second connector at the server.

7. The method of claim 6, further comprising determining whether the first result is inconsistent with the second result.

8. The method of claim 7, further comprising selecting a high priority result from the first result and the second result.

9. The method of claim 8, wherein selecting the high priority result comprises selecting a high priority connector from the connector and the second connector.

10. A policy enforcement system comprising:
a connector database to relate a plurality of connectors monitoring a plurality of assets to the plurality of assets;
a policy engine to receive an assignment of a first policy to a first asset, to select one or more connectors monitoring the first asset using the connector database, and to push the first policy to the selected one or more connectors; and
a plurality of connectors to execute automated checks specific to asset types against assets, wherein the one or more selected connectors execute one or more automated checks to enforce the first policy against the first asset using information about an asset type of the first asset.

11. The policy enforcement system of claim 10, wherein the one or more selected connectors is further to inform the policy engine that no automated checks are available to enforce the first policy.

12. The policy enforcement system of claim 11, wherein the policy engine is further to deploy a manual check to enforce the first policy against the first asset in response to being informed by the one or more selected connectors about the unavailability of automated checks.

13. The policy enforcement system of claim 12, wherein the policy engine deploys a manual check by sending a survey to be completed by an owner of the first asset.

14. The policy enforcement system of claim 10, wherein the policy engine is further to receive results from the one or more selected connectors having executed the one or more automated checks to enforce the first policy against the first asset.

15. The policy enforcement system of claim 14, wherein the policy engine is farther to prioritize the received results received form the one or more selected connectors.

16. The policy enforcement system of claim 15, wherein the policy engine prioritizes the received results by comparing priorities of the one or more selected connectors using the connector database.

17. A machine-readable medium having stored thereon data representing instructions that, when executed by a processor, cause the processor to perform operations comprising:
receiving, at a connector managing a plurality of assets, an assignment of a policy to a first asset of the plurality of assets from a server;
attempting to retrieve one or more automated checks to enforce the policy against the first asset using information about an asset type of the first asset; and
executing the retrieved automated checks against the first asset if at least one automated check was retrieved.

18. The machine-readable medium of claim 17, wherein the instructions further cause the processor to send a message to the server to inform the server that no automated checks are available if the attempting to retrieve one of more automated checks is unsuccessful.

19. The machine-readable medium of claim 17, wherein the instruction further cause the processor to perform operations comprising:
receiving, at a second connector managing a plurality of assets, an assignment of a policy to the first asset of the plurality of assets from the server;
attempting, by the second connector, to retrieve one or more second automated checks to execute the policy against the first asset using information about an asset type of the first asset; and
executing, by the second connector, the retrieved second automated checks against the first asset if at least one second automated check was retrieved.
